(19) United States
(12) Patent Application Publication
(10) Pub. No.: US 2010/0049754 A1
(43) Pub. Date: Feb. 25, 2010

(54) STORAGE SYSTEM AND DATA MANAGEMENT METHOD

(75) Inventors: Nobumitsu TAKAOKA, Sagamihara (JP); Atsushi SUTOH, Yokohama (JP)

Correspondence Address: BRUNDIDGE & STANGER, P.C., 1700 DIAGONAL ROAD, SUITE 330, ALEXANDRIA, VA, 22314, US

(73) Assignee: Hitachi, Ltd.

(21) Appl. No.: 12/243,004

(22) Filed: Oct. 1, 2008

(30) Foreign Application Priority Data
Aug. 21, 2008 (JP) 2008-213154

(51) Int. Cl. G06F 12/02

(52) U.S. Cl. 707/205; 707/E17.01; 707/E17.044

(57) ABSTRACT

In a NAS apparatus, a processor reads in, from a data volume, metadata of all files included in a file system at a base point-in-time of a snapshot of the data volume, and writes all the read-in metadata to an area of a difference data storage volume (difference volume), and in a storage apparatus, a difference data save processing unit, upon receiving a block write request from the latest base point-in-time to the subsequent base point-in-time, chronologically writes data stored in a block specified by the block write request to an area subsequent to the difference data storage volume area.

### CROSS-REFERENCE TO PRIOR APPLICATION

This application relates to and claims the benefit of priority from Japanese Patent Application number 2008-213154, filed on Aug. 21, 2008 the entire disclosure of which is incorporated herein by reference.

### BACKGROUND

The COW (Copy On Write) technique has been known for some time as a data protection technique for restoring a volume in a storage apparatus to a prescribed point in time.

When a write is generated to a certain area (storage area) of a volume, the COW technique saves data that has already been written to this area to another volume (a difference volume). In accordance with this COW technique, the state (image: snapshot) of a volume at a prescribed base point-in-time can be restored based on the current volume data and the data that has been saved to the difference volume.

Using this technique, it is possible to manage snapshots of a plurality of base points-in-time, that is, snapshot generations.

Meanwhile, a file server, which provides a service that enables a file to be accessed as a unit, is known. The file server stores a file system for managing the file in a volume of a storage apparatus, and uses the file system to provide file access service. There are also cases in which a file system-storing volume can be restored by using the COW technique for the volume in which such a file system is stored.

As a technique for managing a plurality of generations of snapshots of a file system, for example, there is known a technique that incorporates file system-denoting metadata inside the file system, and comprises the metadata related thereto in a snapshot (see Japanese Patent Application Laid-open No. 2004-38929).

In the technique of Japanese Patent Application Laid-open No. 2004-38929, a time stamp and so forth are stored in the snapshot metadata, making it possible to determine if a desired version of the file system is comprised in a volume.

There are times, for example, when a user, who is using the file server, needs the data of a previous state of a certain file.

In a case like this, the user is not necessarily aware of when this file was last updated. Accordingly, the user must create a certain base point-in-time snapshot of this volume, and use this snapshot to determine if the pertinent file is the data of the required state. If it is not the data of the required state, the user must also create a snapshot of a different base point-in-time, and must determine once again if this is the required data.

For example, according to the technique of Japanese Patent Application Laid-open No. 2004-38929, it is possible to ascertain the version of the file system at the point-in-time at which the snapshot was taken, but no determination can be made about the status of a file inside this file system, and, as a result, snapshots of respective generations must be taken, and determinations must be made as to whether or not the respective files are the desired file.

### SUMMARY

Accordingly, an object of the present invention is to provide technology that makes it easy to recognize information related to the updating of a file managed by a file system.

To achieve the above-mentioned object, a storage system related to an aspect of the present invention is a storage system having a storage apparatus, which stores a volume that stores, for one or more files, a file system comprising real data and metadata comprising file update time information, and which receives a block write request that specifies a block of the volume; and a file server, which receives from a computer a file write request that specifies a file, specifies a block of the volume in which the file specified by the file write request is stored, and sends a block write request that specifies the specified volume block to the storage apparatus, and the file server has a write processing unit, which reads from the volume the metadata of all the files included in the file system at a plurality of base points-in-time serving as bases for the restoration of the volume, and sequentially writes all the read-in metadata to a prescribed difference data recording volume of the storage apparatus, and the storage apparatus, upon receiving a block write request from the latest base point-in-time to the subsequent base point-in-time, has a difference data save processing unit, which chronologically writes the data stored in the block specified by the block write request to a storage area subsequent to the storage area in which the metadata of the difference data recording volume is stored.

### BRIEF DESCRIPTION OF THE DRAWINGS

FIG. 1 is a diagram illustrating an overview of a storage system related to an embodiment of the present invention;

FIG. 2 is a logical block diagram of the storage system related to an embodiment of the present invention;

FIG. 3 is a block diagram of a NAS apparatus related to an embodiment of the present invention;

FIG. 4 is a block diagram of the hardware of a storage apparatus related to an embodiment of the present invention;

FIG. 5 is a functional block diagram of the storage apparatus related to an embodiment of the present invention;

FIG. 6 is a diagram showing an example of a RAID group configuration table related to an embodiment of the present invention;

FIG. 7 is a diagram showing an example of a volume configuration table related to an embodiment of the present invention;

FIG. 8 is a diagram showing an example of a difference management configuration table related to an embodiment of the present invention;

FIG. 9 is a diagram showing an example of a difference volume group configuration table related to an embodiment of the present invention;

FIG. 10 is a diagram showing an example of a generation management table related to an embodiment of the present invention;

FIG. 11 is a diagram showing an example of a COW map related to an embodiment of the present invention;

FIG. 12 is a flowchart of a generation creation process of the NAS apparatus related to an embodiment of the present invention;

FIG. 13 is a flowchart of a generation creation process of the storage apparatus related to an embodiment of the present invention;

FIG. 14 is a diagram illustrating a collection of metadata related to an embodiment of the present invention;

FIG. 15 is a flowchart of a file write process related to an embodiment of the present invention;

FIG. 16 is a flowchart of a host write process related to an embodiment of the present invention;

FIG. 17 is a diagram illustrating a host write process related to an embodiment of the present invention;

FIG. 18 is a flowchart of a restore process of the NAS apparatus related to an embodiment of the present invention;

FIG. 19 is a flowchart of a restore process of the storage apparatus related to an embodiment of the present invention;

FIG. 20 is a flowchart of a filename tracking process related to a variation of the present invention;

FIG. 21 is a flowchart of a filename tracking process of a data volume related to a variation of the present invention; and

FIG. 22 is a flowchart of a filename tracking process of a virtual volume related to a variation of the present invention.

### DESCRIPTION OF THE PREFERRED EMBODIMENTS

The embodiment of the present invention will be explained by referring to the figures. Furthermore, the embodiment explained hereinbelow does not limit the invention covered in the claims, and not all of the elements and combinations thereof explained in the embodiment are essential to the invention's means for solving the problem.

First, an overview of a storage system related to an embodiment of the present invention will be explained.

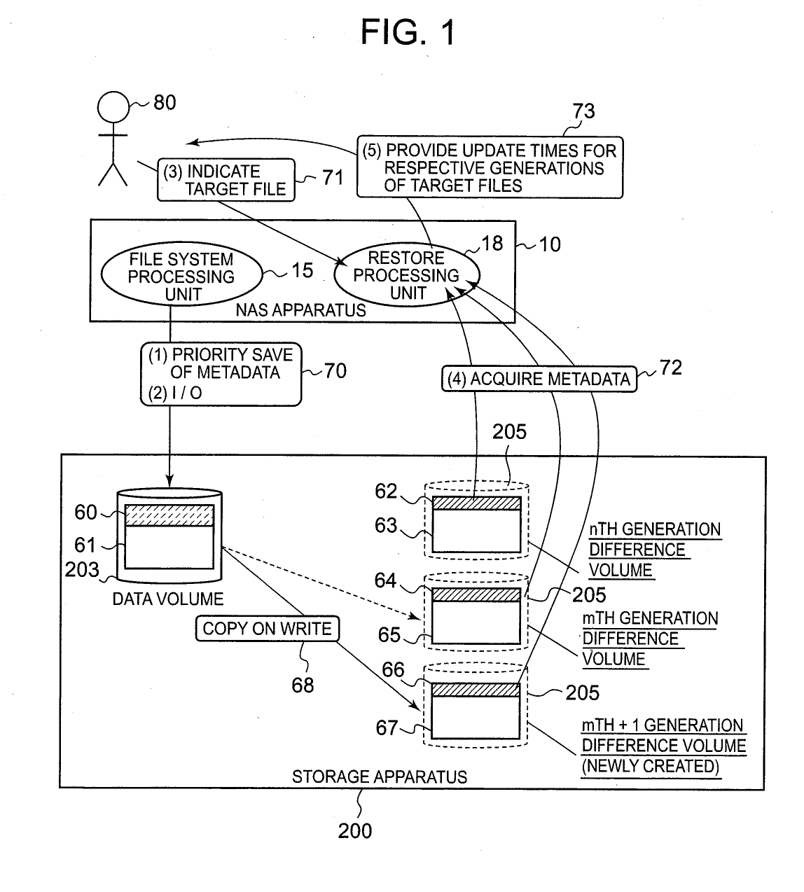

FIG. 1 is a diagram illustrating an overview of the storage system related to an embodiment of the present invention.

In storage system 1, a file system processor 15 of a NAS (Network Attached Storage) apparatus 10 commences the execution of a process (generation creation process: FIG. 1 (1)) that preferentially sequentially saves metadata of a point in time that is the base of a prescribed snapshot (base point-in-time). A storage apparatus 200 commences the execution of a generation creation process on the storage apparatus 200 side in response to the NAS apparatus 10 commencing the execution of the generation creation process. That is, the storage apparatus 200 newly creates a virtual difference volume 205 for storing the difference data in a generation from a base point-in-time to the subsequent base point-in-time (for example, the mth+1 generation when the generation up until now is the mth generation). Then the NAS apparatus 10 reads out the metadata 60 of all the files of the file system stored in a data volume 203, and writes the read-out data to a block that will store the metadata 60 of the data volume 203. In response to this write process, the storage apparatus 200 saves the metadata 60 to contiguous storage areas (metadata storage areas) 66 at the head of the difference volume 205.

Thereafter, when the NAS apparatus 10 receives a file write request from an external computer, the NAS apparatus 10 creates a block write request that corresponds to the file write request, and sends the block write request to the storage apparatus 200 (FIG. 1 (2)).

The storage apparatus 200, upon receiving the block write request, stores the data and so forth (difference data) stored in the write-targeted block of the data volume 203 in a storage area 67 subsequent to the metadata storage area 66 of the difference volume 205 of the newly created generation, and stores the write-targeted data in the corresponding block of the data volume 203 (Copy On Write 68). The storage apparatus 200 executes a process like this every time a block write request is received.

Then, when the NAS apparatus 10 subsequently receives from a user an indication 71 for a desired restore-targeted file (target file: restore target file) (FIG. 1 (3)), the restore processor 18 of the NAS apparatus 10 acquires from the storage apparatus 200 the metadata 62, 64, 66, which are stored at the head of the difference volume 205, of respective generations corresponding to respectively different base points-in-time, and based on the pertinent metadata, acquires the update time for the restore target file, and provides the update times of the target files of the respective generations to the user (FIG. 1 (5)).

Consequently, the user is able to comprehend the update times of the respective generations of the target file, and is able to appropriately discern the generation to be restored in order to acquire the file of the desired state (desired point in time).

Next, the storage system related to an embodiment of the present invention will be explained in detail.

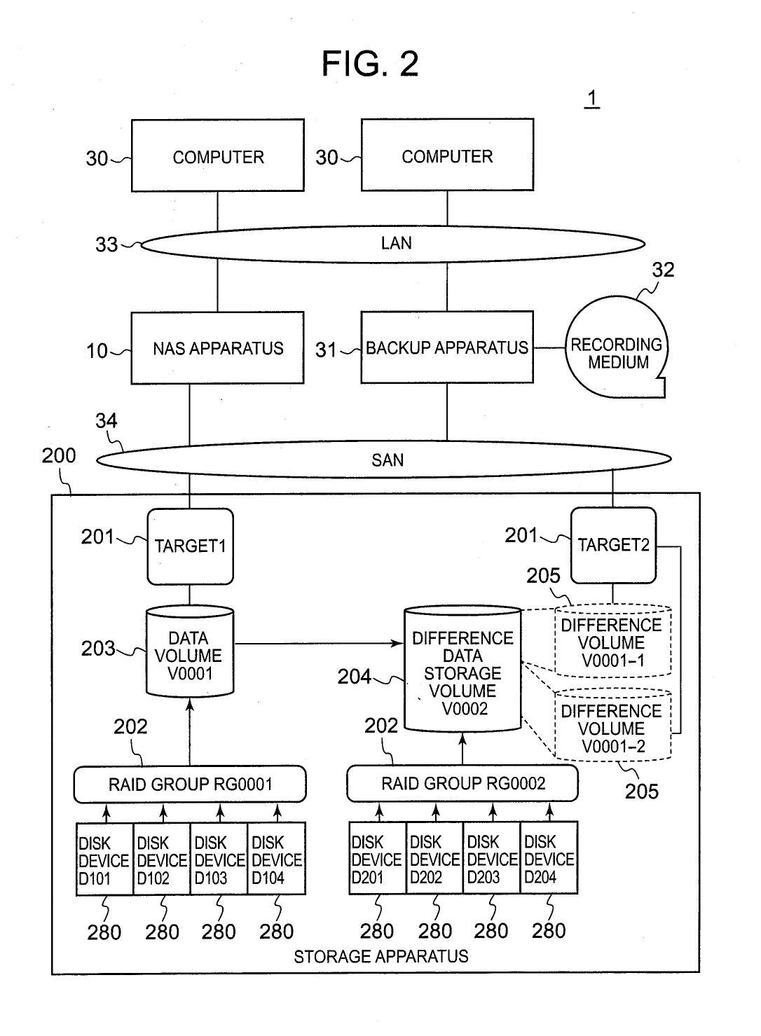

FIG. 2 is a logical block diagram of the storage system related to an embodiment of the present invention.

The storage system 1 has one or more computers 30; a NAS apparatus 10 as an example of a file server; a backup apparatus 31 as an example of an external device; and a storage apparatus 200.

The computer 30, NAS apparatus 10 and backup apparatus 31, for example, are connected via a LAN (Local Area Network). Furthermore, the network that connects these components is not limited to a LAN, and can be any network, such as the Internet, a leased line, or public switched lines.

Further, the NAS apparatus 10, backup apparatus 31 and storage apparatus 200, for example, are connected via a SAN (Storage Area Network). The network that connects these components is not limited to a SAN, and can be a network that is capable of carrying out prescribed data communications.

The computer 30 executes prescribed processing by using a processor not shown in the figure to execute an OS (Operating System) and an application, and sends a file access request (a file write request or file read request) to the NAS apparatus 10 in accordance with the process. A file write request sent from the computer 30, for example, comprises data (file identification data: for example, a filename, directory pathname, and so forth) for identifying the write-targeted (write target) file and the write-targeted data.

The NAS apparatus 10 receives the file access request from the computer 30, specifies the block of the volume in the storage apparatus 200 in which the file specified by the file access request is stored, and sends a block access request (block write request or block read request) that specifies the specified volume block to the storage apparatus 200. The block write request sent by the NAS apparatus 10, for example, comprises the number (LUN: Logical Unit Number) of the logical unit (LU: Logical Unit) in which the write-targeted data is being managed, and the block address in the logical unit (LBA: Logical Block Address).

The backup apparatus 31 carries out the input/output of data to/from a tape or other such recording medium 32. For example, the backup apparatus 31 receives data of a prescribed volume of the storage apparatus 200 via the SAN 34, and writes this data to the recording medium 32. Further, the backup apparatus 31 reads out the saved volume data from the recording medium 32, and writes this data to the storage apparatus 200.

The storage apparatus 200 has a plurality of disk devices (HDD) 280. In this embodiment, a RAID (Redundant Array of Independent Disks) group 202 is configured from a plurality (for example, four) disk devices 280 in the storage apparatus 200. In this embodiment, the RAID level of a RAID group, for example, is RAID 1, 5 or 6. In the storage apparatus 200, there are created volumes (data volume 203, difference data storage volume 204, and so forth) that treat at least a portion of the storage areas of the RAID group 202 as their own storage areas, and there is also created a difference volume 205, which is a virtual volume that treats at least a portion of the storage area of the difference data storage volume 204 as its own storage area. The storage apparatus 200 has a plurality of targets (ports) 201, and one or more volumes (data volume 203, difference data storage volume 204, difference volume 205, and so forth) are connected to each target 201. Furthermore, the respective volumes connected to the respective targets 201 are managed by being made correspondent to the LUN, the NAS apparatus 10 can specify the volume to be targeted by specifying a LUN, and the storage apparatus 200 can specify the volume to be targeted from the specified LUN.

In this embodiment, a file system for enabling the NAS apparatus 10 to manage file access is created (stored) in the data volume 203. The file system has file system information, metadata, which is information related to a file, and the real data of a file. File system information, for example, comprises the file system size, free capacity, and so forth. Further, file identification data (a filename), information that specifies the block in which the real file data is stored (for example, a LBA), and information related to the file update time (update date/time) is stored in the metadata. For example, in the case of a file system that uses an inode, the metadata includes a directory entry that manages the correspondence relationship of the number of an inode (inode number) that corresponds to a file, and an inode table that manages the inode. An inode number, the block address (block number) in which corresponding data is stored, and the file update time are stored in the inode.

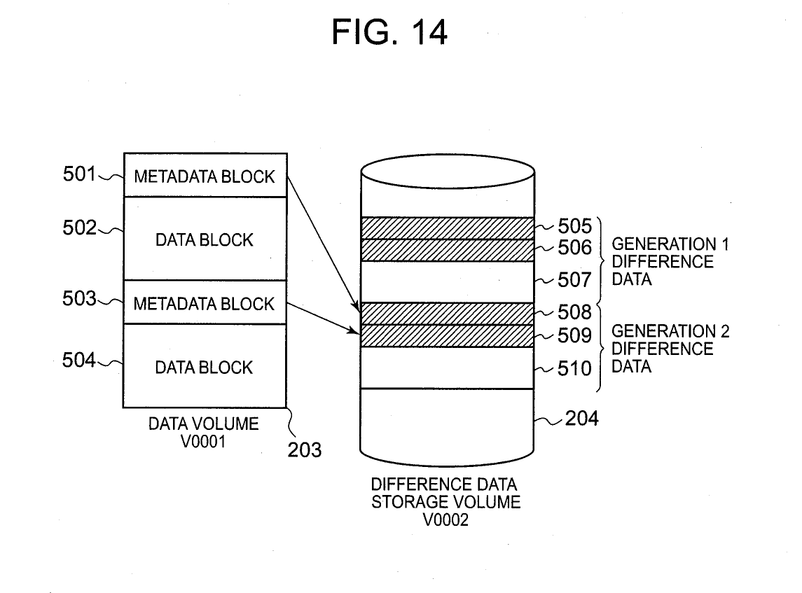

In the data volume 203, for example, there are metadata blocks 501, 503 that store metadata, and data blocks 502, 504 that store real data as shown in FIG. 14.

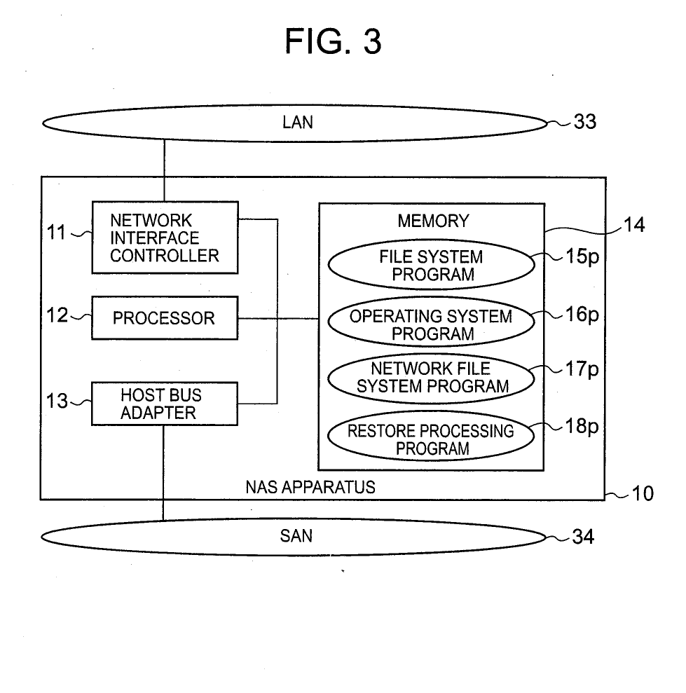

FIG. 3 is a block diagram of the NAS apparatus related to an embodiment of the present invention.

The NAS apparatus 10 has a network interface controller 11; a processor 12; a host bus adapter 13; and a memory 14. The network interface controller 11 mediates the exchange of data with the computer 30 via the LAN 33. The host bus adapter 13 mediates the exchange of data with the storage apparatus 200 via the SAN 34.

The processor 12 executes various processes using a program and data stored in the memory 14. Here, the processor 12 configures a write processing unit, identification data receiving unit, retrieving unit, acquisition unit, presentation unit, determination unit, restore specification processing unit, and a cache controller by executing various programs in the memory 14.

The memory 14 stores programs and data. In this embodiment, the memory 14 stores a file system program 15p for executing file system-related processes; an operating system program 16p for executing input/output processes; a network file system program 17p for executing processes related to file sharing over a network; and a restore processing program 18p for executing a restore.

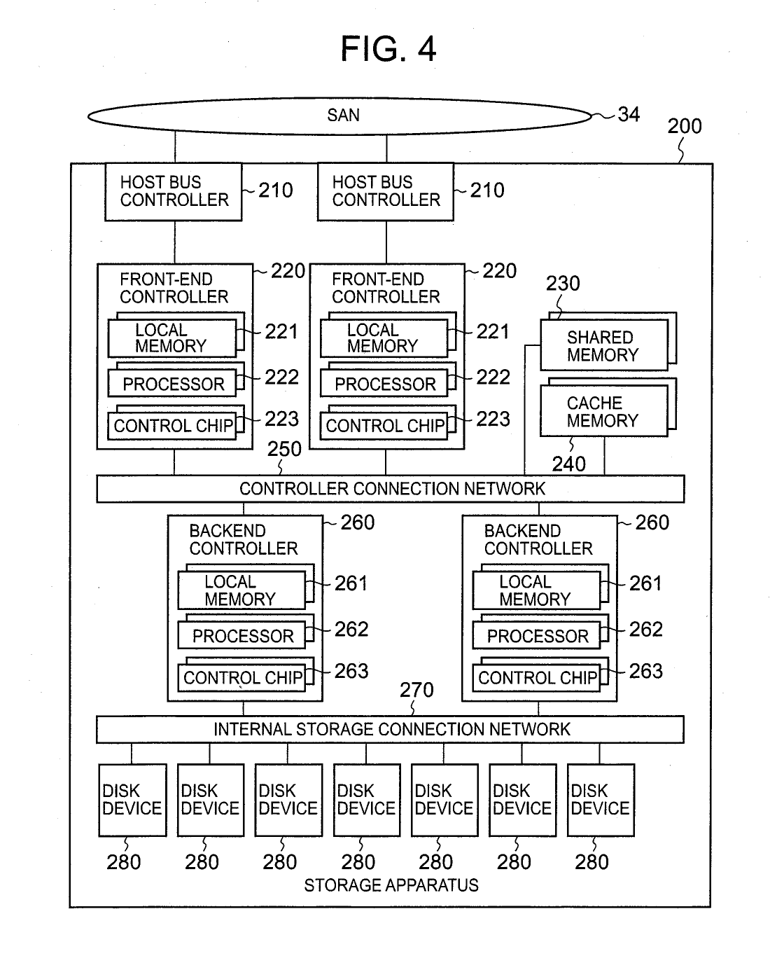

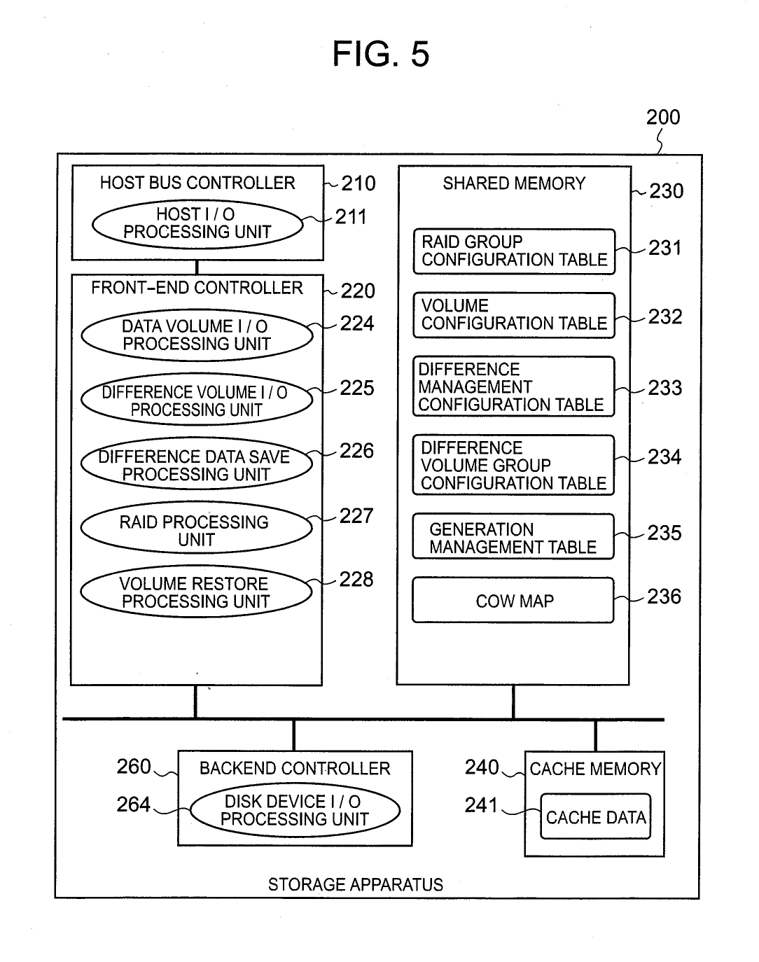

FIG. 4 is a block diagram of the hardware of the storage apparatus related to an embodiment of the present invention, and FIG. 5 is a functional block diagram of the storage apparatus related to an embodiment of the present invention.

The storage apparatus 200 has one or more host bus controllers 210; one or more front-end controllers 220; a shared memory 230; a cache memory 240; one or more backend controllers 260; and a plurality of disk devices 280. The host bus controller 210 is connected to the SAN 34, and is also connected to the front-end controller 220. The front-end controller 220, the shared memory 230, which is an example of a semiconductor memory, the cache memory 240, which is an example of a semiconductor memory, and the backend controller 260 are connected by way of a controller connection network 250. The backend controller 260 and disk devices 280 are connected by way of an internal storage connection network 270.

The host bus controller 210 has a host I/O processor 211 as shown in FIG. 5, and mediates the exchange of data with the NAS apparatus 10 via the SAN 34.

The front-end controller 220 has a local memory 221; a processor 222; and a control chip 223. The processor 222 in the front-end controller 220 executes programs stored in a local memory 221 to configure a data volume I/O processing unit 224, a difference volume I/O processing unit 225, a difference data save processing unit 226, a RAID processing unit 227, and a volume restore processing unit 228 as an example of a restore processing unit.

The data volume I/O processing unit 224 executes a process related to accessing the data volume in which the file system is stored. The difference volume I/O processing unit 225 executes a process related to accessing a difference data storage volume in which difference data is stored. The difference data save processing unit 226 executes a process that saves difference data. The RAID processing unit 227 executes a process that converts data targeted to be written to a volume by the data volume I/O processing unit 224 or difference volume I/O processing unit 225 to data that is written to the respective disk devices 280 configuring a RAID group, and a process that converts data read out from the respective disk devices 280 configuring a RAID group to read-targeted data required by the data volume I/O processing unit 224 or the difference volume I/O processing unit 225. The volume restore processing unit 228 executes a volume restore process.

The shared memory 230 stores a RAID group configuration table 231; a volume configuration table 232; a difference management configuration table 233; a difference volume group configuration table 234; a generation management table 235; and a COW map 236. The configurations of these tables and so forth will be explained in detail hereinbelow.

The cache memory 240 temporarily stores cache data 241, that is, data to be written to a disk device 280, and data that has been read out from a disk device 280.

The backend controller 260 has a local memory 261; a processor 262; and a control chip 263. The processor 262 in the backend controller 260 executes a program stored in the local memory 261 to configure a disk device I/O processing unit 264. The disk device I/O processing unit 264 executes a data write to disk devices 280 and a data read from disk devices 280 in accordance with an indication from the front-end controller 220.

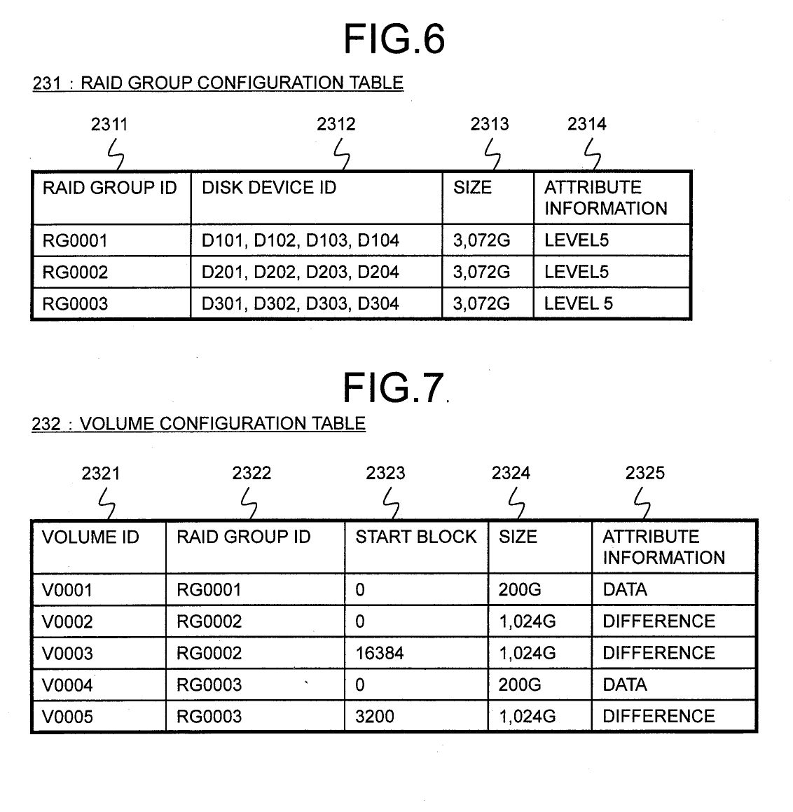

FIG. 6 is a diagram showing an example of a RAID group configuration table related to an embodiment of the present invention.

The RAID group configuration table 231 stores records having a RAID group ID field 2311; a disk device ID field 2312; a size field 2313; and an attribute information field 2314.

An ID (RAID group ID) that identifies a RAID group 202 is stored in the RAID group ID field 2311. IDs (disk device IDs) of disk devices 280 that configure the corresponding RAID group 202 are stored in the disk device ID field 2312. The size (storage capacity) of the storage area of the corresponding RAID group 202 is stored in the size field 2313. The RAID level of the corresponding RAID group 202 is stored in the attribute information field 2314.

For example, the topmost record of the RAID group configuration table 231 shown in FIG. 6 shows that the RAID group 202 ID is “RG0001”, the pertinent RAID group 202 is configured from four disk devices 280 having ID “D101”, “D102”, “D103” and “D104”, the size of the storage area of the RAID group 202 is 3,072 GB (gigabytes), and the RAID level of the RAID group 202 is level 5.

FIG. 7 is a diagram showing an example of a volume configuration table related to an embodiment of the present invention.

The volume configuration table 232 stores records having a volume ID field 2321; a RAID group ID field 2322; a start block field 2323; a size field 2324; and an attribute information field 2325.

The ID of volume (203, 204, and so forth) is stored in the volume ID field 2321. The ID of the RAID group 202 that configures the corresponding volume (provides the storage area) is stored in the RAID group ID field 2322. The number (address) of the block (start block) at which the storage area of the pertinent volume in the corresponding RAID group starts is stored in the start block field 2323. The size (storage capacity) of the storage area of the corresponding volume is stored in the size field 2324. Attribute information of the type of the corresponding volume, for example, is it a volume that stores normal data, or is it a volume that stores difference data, is stored in the attribute information field 2325.

For example, the topmost record of the volume configuration table 232 shown in FIG. 7 shows that the storage area of a volume having the ID “V0001” starts from block “0” of a RAID group 202 having the ID “RG0001”, the size of the storage area is 200 GB, and the volume is used to store normal data.

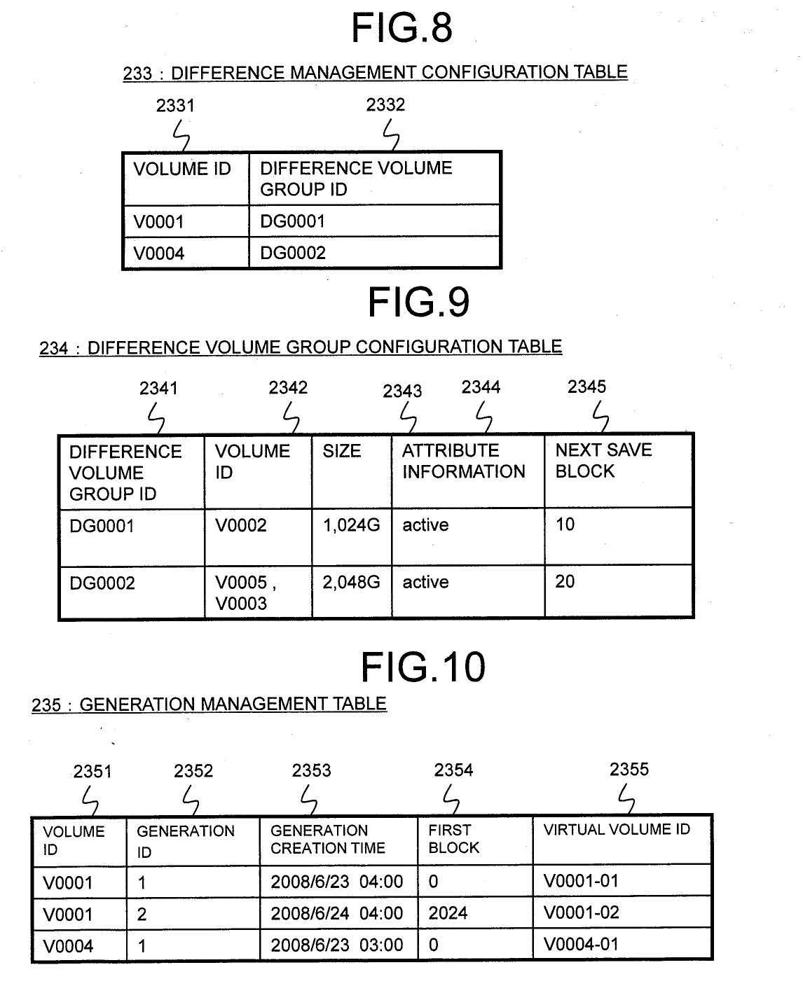

FIG. 8 is a diagram showing an example of a difference management configuration table related to an embodiment of the present invention.

The difference management configuration table 233 stores records having a volume ID field 2331; and a difference volume group ID field 2332.

The ID of a volume (for example, 203) for storing file system data is stored in the volume ID field 2331. The ID (difference volume group ID) of a group of volumes (difference data storage volumes) for storing the difference data of the corresponding volumes is stored in the difference volume group ID field 2332.

For example, the topmost record on the difference management configuration table 233 shown in FIG. 8 shows that the difference data of a volume having the ID “V0001” is stored in the difference volume group of “DG0001”.

FIG. 9 is a diagram showing an example of a difference volume group configuration table related to an embodiment of the present invention.

The difference volume group configuration table 234 stores records having a difference volume group ID field 2341; a volume ID field 2342; a size field 2343; an attribute information field 2344; and a next save block field 2345.

The ID of a difference volume group is stored in the difference volume group ID field 2341. The ID of a volume that belongs to the corresponding difference volume group is stored in the volume ID field 2342. The size of the storage area of the difference volume group is stored in the size field 2343. The action state (for example, “active”) of the difference volume group is stored in the attribute information field 2344. The block number of the difference volume group that will store the subsequent difference data is stored in the next save block field 2345.

For example, the topmost record of the difference volume group configuration table 234 shown in FIG. 9 shows that the difference volume group of the ID “DG0001” is configured from the volume with the ID “V0002”, the size of the storage area is 1024 GB, the difference volume group is active, and the block that constitutes the next save destination is the tenth block.

FIG. 10 is a diagram showing an example of a generation management table related to an embodiment of the present invention.

The generation management table 235 stores records having a volume ID field 2351; a generation ID field 2352; a generation creation time field 2353; a first block field 2354; and a virtual volume ID field 2355.

The ID of the volume, which stores file system data, is stored in the volume ID field 2351. An ID that denotes a generation (a generation number) is stored in the generation ID field 2352. The time when the generation was created (base point-in-time) is stored in the generation creation time field 2353. The number of the first block in the difference volume group, which stores the data of the corresponding generation, is stored in the first block field 2354. The ID of a virtual volume, which stores the difference data of the corresponding generation, is stored in the virtual volume ID field 2355.

For example, the topmost record of the generation management table 235 shown in FIG. 10 shows that the generation, for which the generation ID of the volume having the ID “V0001” is “1”, was created “2008/6/23 04:00”, the first block of the difference volume group is “0”, and the ID of the virtual volume that stores the difference data of the pertinent generation is “V0001-01”.

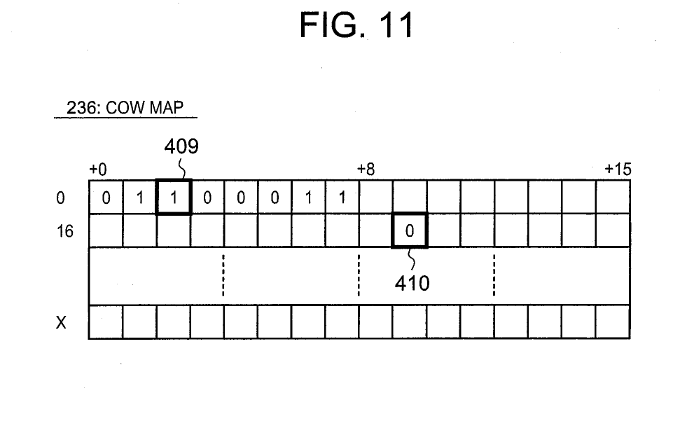

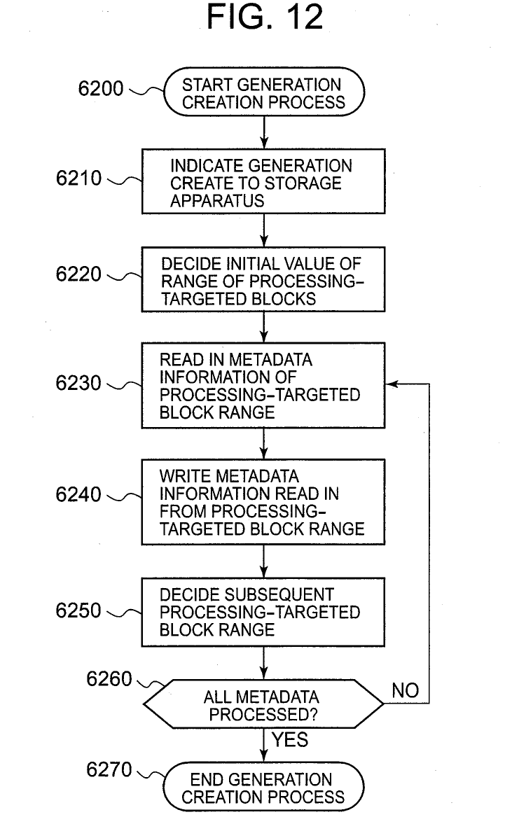

FIG. 11 is a diagram showing an example of a COW map related to an embodiment of the present invention.

The COW map 236 is a map, which is provided corresponding to a volume in which file system data is stored, and which manages whether or not a data update occurred on or after a prescribed base point-in-time for the respective blocks in the corresponding volume. Specifically, the COW map 236 has bits that correspond to the respective blocks in a volume, and “0” is stored in the COW map 236 when there has not been an update for the corresponding block, and “1” is stored when an update has occurred for the corresponding block.

For example, the COW map 236 shown in FIG. 11 shows that the third block has been updated since the corresponding bit 409 is “1”, and that the 26th block has not been updated since the corresponding block 410 is “0”.

Next, the operation of the storage system 1 related to the present invention will be explained.

FIG. 12 is a flowchart of a generation creation process of the NAS apparatus related to an embodiment of the present invention.

This generation creation process commences when it becomes the point in time constituting the base of a pre-configured snapshot, or when the NAS apparatus 10 receives an indication from the user.

When the generation creation process commences (Step 6200), the processor 12, which executes the file system program 15p, sends a generation create indication to the storage apparatus 200 (Step 6210).

Next, the processor 12 decides the initial value of the range (range of processing-targeted blocks) of blocks of the data volume 203, which stores the file system that is the target of the processing (Step 6220). For example, the processor 12 acquires information denoting the block that stores the metadata from the data for managing the file system, and decides the range of the first block as the initial value.

The processor 12 reads in the metadata from the processing-targeted block range of the data volume 203 (Step 6230), and causes the storage apparatus 200 to write the read-in metadata to the difference data storage volume 204 for storing the difference data of the data volume 203 (Step 6240). Specifically, the difference volume I/O processing unit 225 of the storage apparatus 200 writes the corresponding metadata to the difference data storage volume 204.

Next, the processor 12 decides the range of the processing-targeted blocks in which the subsequent metadata is stored (Step 6250), and determines whether or not all of the metadata of the files in the file system have been processed (Step 6260), and when all the metadata has not been processed, executes the steps from Step 6230, and conversely, when all the metadata has been processed, ends the generation creation process (Step 6270).

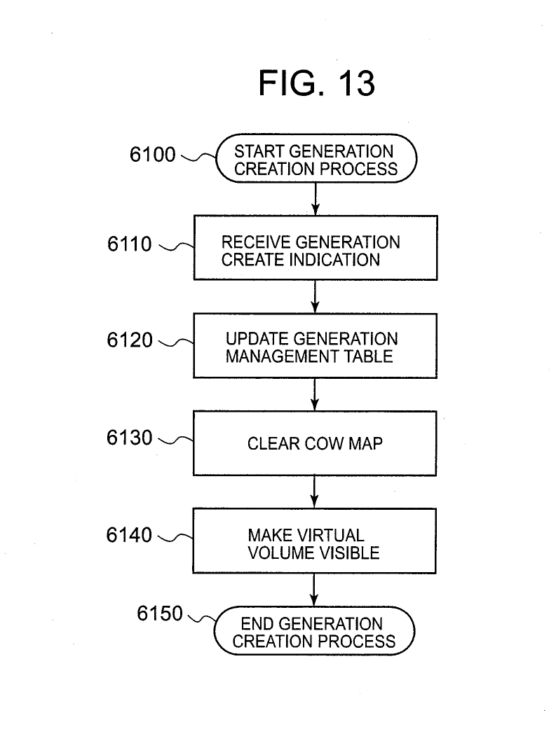

FIG. 13 is a flowchart of a generation creation process of the storage apparatus related to an embodiment of the present invention.

The repeated execution of the generation creation process in the storage apparatus 200, for example, commences subsequent to the storage apparatus 200 being ramped up.

When the generation creation process commences (Step 6100) and a generation create indication is received from the NAS apparatus 10 (Step 6110), the difference data save processing unit 226 adds a new record related to the new generation to the generation management table 235, and writes the data to the respective fields of the record (Step 6120). For example, the difference data save processing unit 226 stores the ID of the volume, in which the file system that is to create the generation is stored, in the volume ID field 2351, stores the ID of the generation subsequent to the generation ID, which has already been registered for the same volume, in the generation ID field 2352, stores the time (date/time) at which the generation create indication was received in the generation creation time field 2353, stores the number of the block subsequent to the block in which the previous generation data is stored in the first block field 2354, and stores the ID of the virtual volume for storing the difference data related to the new generation to be created in the virtual volume ID field 2355.

Next, the difference data save processing unit 226 configures the respective bits of the COW map 236 to “0” (Step 6130). Next, the difference data save processing unit 226 makes the virtual volume that is to store the difference data of the new generation to be created visible, that is, configures the various information necessary to reference the virtual volume from the NAS apparatus 10 in target 2 (Step 6140), and ends processing (Step 6150). Furthermore, subsequent thereto, processing (Step 6240) is executed by the NAS apparatus 10, and the difference volume I/O processing unit 225 writes the metadata to the difference data storage volume 204, and creates mapping information that makes the block of the difference data storage volume 204 into which the metadata was written correspondent to the free first block in the virtual volume 205 of the corresponding generation, and stores this mapping information in the shared memory 230. Consequently, the metadata is stored in the first collecting area (metadata storage area) of the virtual volume 205, and difference data is stored in the area subsequent thereto in the virtual volume 205.

FIG. 14 is a diagram illustrating a collection of metadata related to an embodiment of the present invention.

FIG. 14 shows the state of the difference data storage volume 204 when generation creation processing (FIGS. 12 and 13) for storing the difference data of a subsequent new generation, that is, generation 2, after the difference data corresponding to generation 1 has been created.

As shown in FIG. 14, all the metadata of metadata blocks 503, 504 of the data volume 203 at the base point-in-time which created generation 2 is stored in the areas (metadata difference areas) 508, 509 directly after the storage area 507 of the generation 1 difference data of the difference data storage volume 204. Furthermore, the difference data related to the data volume 203 subsequent to the base point-in-time that created generation 2 is chronologically stored in area 510 directly after area 509.

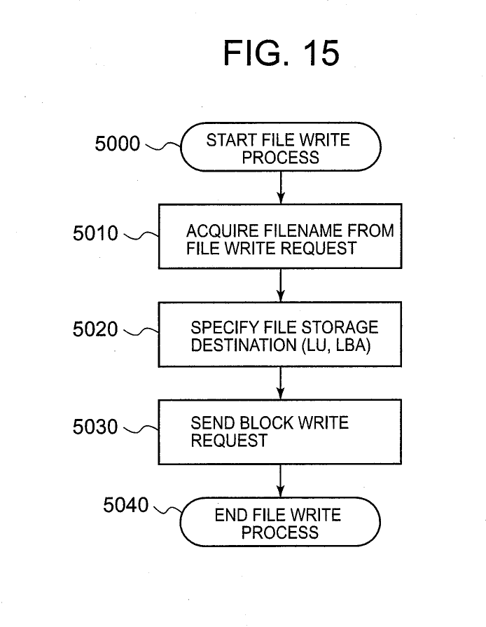

FIG. 15 is a flowchart of a file write process related to an embodiment of the present invention.

Repeated execution of the file write process, for example, commences after the NAS apparatus 10 has been ramped up.

When the file write process execution commences in the NAS apparatus 10 (Step 5000), and a file write request is received from the computer 30 via the network interface controller 11, the processor 12, which executes the file system program 15p, acquires a filename from the file write request (Step 5010), and specifies a file storage destination (LU and LBA) based on the filename. Furthermore, since the NAS apparatus 10 itself manages the LU, the NAS apparatus 10 is able to recognize the LU that corresponds to the data volume 203 in which the file system is stored. Further, the NAS apparatus 10 can use the filename to specify the LBA on the basis of the file system metadata.

Next, the processor 12 sends a block write request comprising the specified LU and LBA, and the write-targeted data to a prescribed host bus controller 210 of the storage apparatus 200 by way of a host bus adapter 13 (Step 5030), and ends processing (Step 5040).

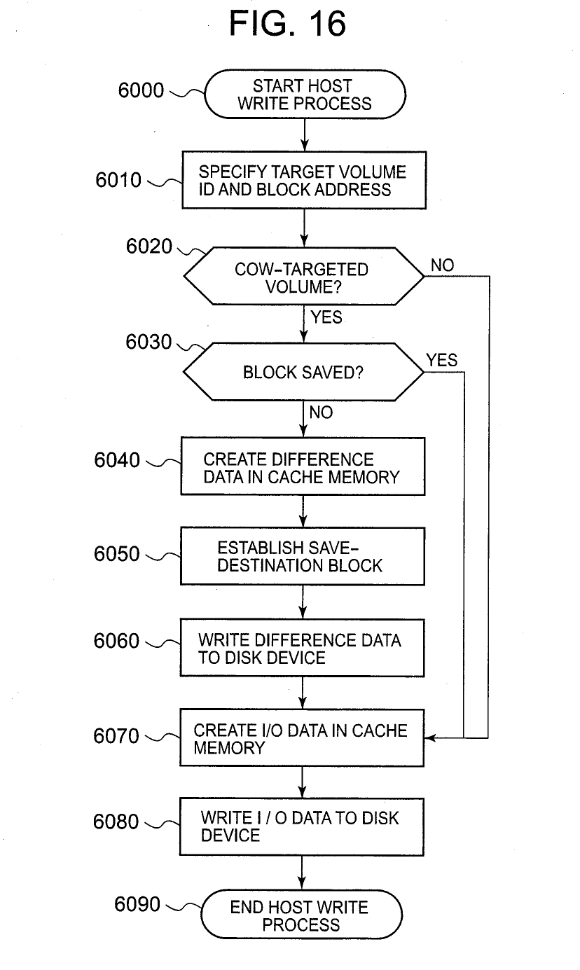

FIG. 16 is a flowchart of a host write process related to an embodiment of the present invention.

The host write process commences when a block write request is received from the NAS apparatus 10. When the host write process commences (Step 6000), the data volume I/O processing unit 224 specifies the write-targeted volume ID and a LBA based on the LUN and LBA comprised in the block write request (Step 6010). Furthermore, a not-shown mapping table, which manages the correspondence relationship between the LUN and volume ID, is stored in the storage apparatus 200, and the data volume I/O processing unit 224 can use the mapping table to specify the volume ID of the write-targeted volume based on the LUN comprised in the block write request. Further, the LBA can be acquired from the block write request.

Next, the data volume I/O processing unit 224 determines if the write-targeted volume is the COW-targeted volume by whether or not the volume ID of the write-targeted volume is registered in the difference management configuration table 233 (Step 6020), and when the write-targeted volume is not the COW-targeted volume (Step 6020: NO), proceeds to Step 6070.

Conversely, when the write-targeted volume is the COW-targeted volume (Step 6020: YES), the difference data save processing unit 226 references the COW map 236, determines if the difference data comprising the data of the write-targeted block has already been saved to the difference data storage volume 204 (Step 6030), and when this difference data has already been saved, the saved difference data can be used to return to the state of the base point-in-time, so the difference data save processing unit 226 proceeds to Step 6070 without saving.

Conversely, when this difference data has not been saved (Step 6030: NO), the difference data save processing unit 226 creates the difference data in the cache memory 240 based on the data of the write-targeted block (Step 6040), then acquires the block that will constitute the save destination of the difference data from the next save block field 2345 of the difference volume group configuration table 234, and updates the pertinent next save block field 2345 to the subsequent block (Step 6050).

Next, the difference volume I/O processing unit 225 writes the difference data of the cache memory 240 to the block specified by the difference data storage volume 204 (Step 6060). Further, in this embodiment, the difference volume I/O processing unit 225 creates mapping information that makes the block of the difference data storage volume 204 in which the difference data is written correspond to the free first block of the virtual volume of the corresponding generation, and stores this mapping information in the shared memory 230. Consequently, it is possible to chronologically line up the difference data of the corresponding generation in the virtual volume in accordance with the virtual volume block order.

Thereafter, the data volume I/O processing unit 224 stores the write-data in the cache memory 240 (Step 6070), writes the write-data of the cache memory 240 to the disk device 280 corresponding to the block of the write-targeted data volume 203 (Step 6080), and ends the host write process.

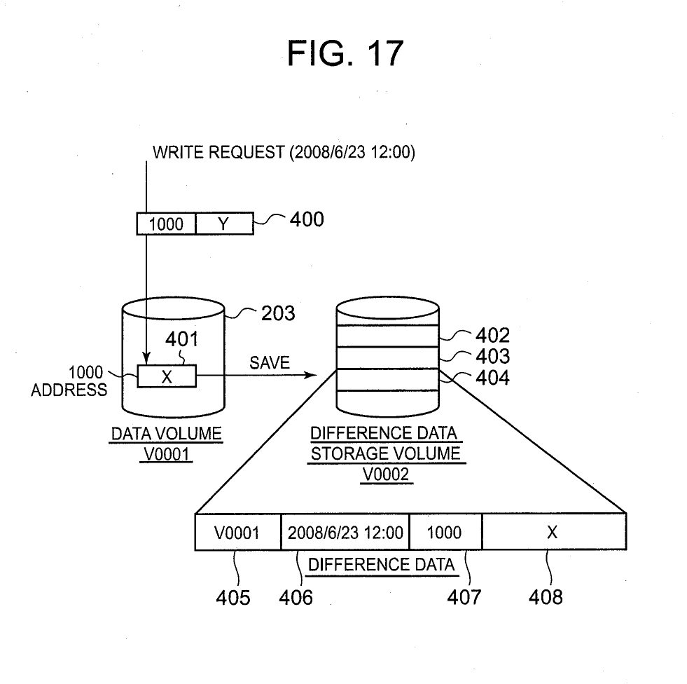

FIG. 17 is a diagram illustrating the host write process related to an embodiment of the present invention.

In the storage apparatus 200, when a block write request to store data Y in address (block) 1000 is received from the NAS apparatus 10, the difference data comprising data X, which is currently stored in address 1000 of the data volume 203 (“V0001”) that is the target of the block write request (write request) is saved to and stored in the difference data storage volume 204 (“V0002”) of the difference volume group that corresponds to the pertinent data volume 203. In this embodiment, the difference data here comprises the ID (“V0001”) of the data volume in which the data is stored, the date/time (“2008/6/23 12:00”) at which the block write request was received, the address (“1000”) of the storage block in the data volume 203, and the stored data (“X”). This difference data makes it possible to restore the data of the post-block write request data volume 203 to the state of the pre-block write request data volume 203 by writing the data back inside the difference data.

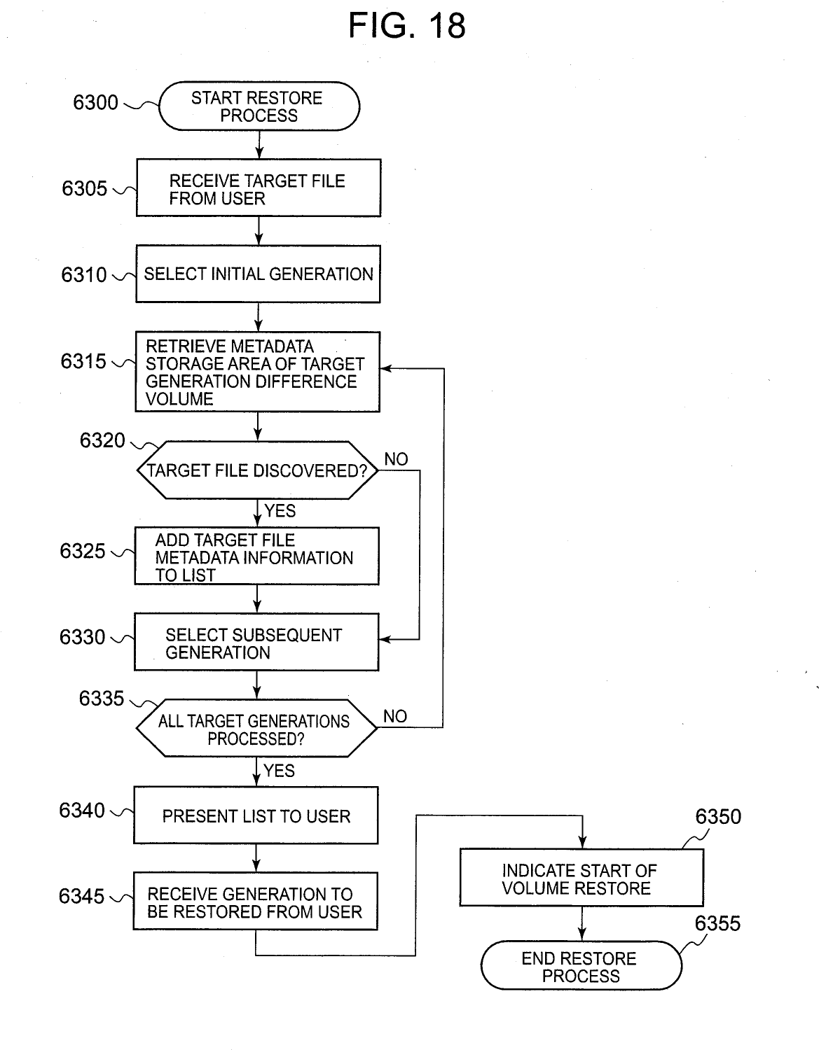

FIG. 18 is a flowchart of a restore process of the NAS apparatus related to an embodiment of the present invention.

When restore process commences in the NAS apparatus 10 (Step 6300), the processor 12, which executes the restore processing program 18p, receives from the user via a not-shown input device the identification data (for example, the filename) of the file (target file) that is targeted to be restored (Step 6305).

The processor 12 selects the initial generation of the file system that is to manage the corresponding file as the processing-targeted generation (Step 6310).

The processor 12 retrieves data showing whether or not a target file exists for the metadata storage area of the difference volume of the processing-targeted generation (Step 6315). In this embodiment, since a determination as to whether or not a target file exists can be made by simply reading in the metadata storage area, which is a portion of the area of the difference volume, a search process can be executed in a short period of time. Then, the processor 12 determines whether or not a target file was found as a result of the search (Step 6320). When the result is that a target file was found (Step 6320: YES), the processor 12 adds the metadata of the target file to the list (Step 6325), and selects (the difference volume of) the subsequent generation as the processing target (Step 6330). Conversely, when a target file is not found (Step 6320: NO), the processor 12 selects the subsequent generation as the processing target (Step 6330).

Next, the processor 12 determines whether or not all the generations of the file system have been processed (Step 6335), and when all the generations have not been processed, once again executes the steps beginning from Step 6315.

Conversely, when all the generations have been processed (Step 6335: YES), the processor 12 presents the list to the user (Step 6340). For example, the processor 12 displays on a display device connected to the NAS apparatus 10 a list that includes one or more generation IDs correspondent to update time (update date/time) of the target file that exists in these generations. Using this displayed list, the user can figure out the update time of the target file.

Next, the processor 12 receives from the user a selection from the list of generations comprising the file of the update time to be restored (Step 6345), sends an indication that causes the storage apparatus 200 to commence a restore of the selected generation (Step 6350), and ends the processing in the NAS apparatus 10 (Step 6355).

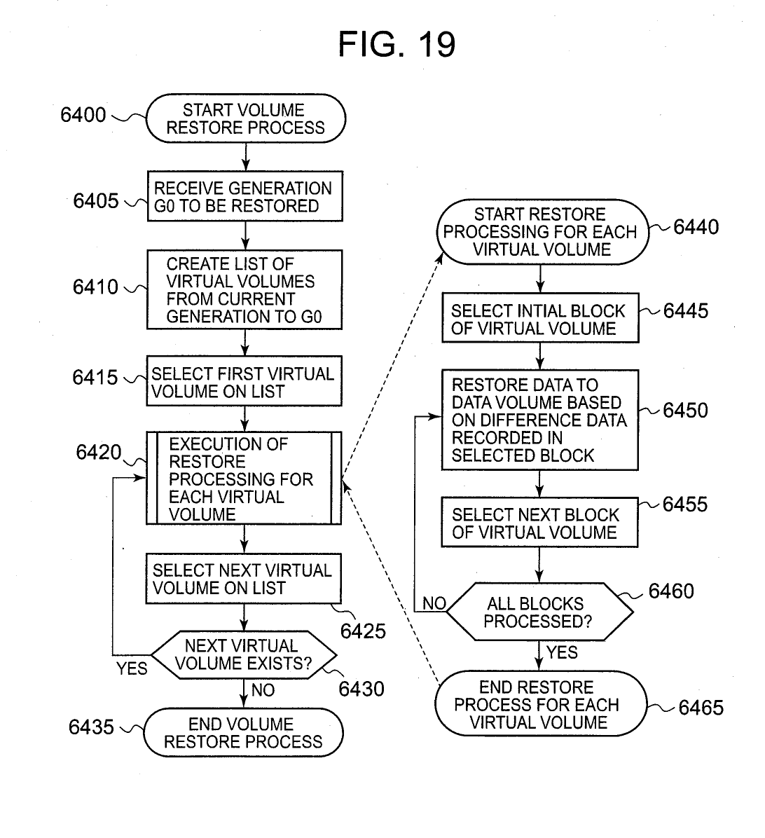

FIG. 19 is a flowchart of a restore process of the storage apparatus related to an embodiment of the present invention.

When volume restore process commences in the storage apparatus 200 (Step 6400), the volume restore processing unit 228 receives from the NAS apparatus 10 a restore start indication comprising the generation to be restored (Step 6405), and creates a processing order list of virtual volumes (difference volumes) 205 from the current generation of the corresponding file system to the generation comprised in the start indication (Step 6410).

Next, the volume restore processing unit 228 selects the first virtual volume 205 on the processing order list as the processing target (Step 6415), and executes restore process for each virtual volume (Step 6420).

In the restore process for each virtual volume, when processing commences (Step 6440), the volume restore processing unit 228 selects the initial block of the virtual volume (Step 6445), and restores the data to the data volume 203 on the basis of the difference data recorded in the selected block (Step 6450). Because the difference data here comprises the data volume ID and storage block in the data volume, as well as the data written to the data volume, it is possible to restore data by storing the data in the storage block of the volume denoted by the difference data ID.

Next, the volume restore processing unit 228 selects the subsequent block of the virtual volume (Step 6455), and specifies whether or not all the blocks of the virtual volume have been processed (Step 6460). When all the blocks have not been restored (Step 6460: NO), the volume restore processing unit 228 once again executes the steps beginning from Step 6450, and if all the blocks have been restored (Step 6460: YES), ends the restore process for each of the virtual volumes (Step 6465).

When restore process for each of the virtual volumes has ended, the volume restore processing unit 228 selects the next virtual volume on the processing order list (Step 6425), and determines whether or not the next virtual volume exists (Step 6430). When there is a subsequent virtual volume (Step 6430: YES), the volume restore processing unit 228 makes this virtual volume the processing target, and executes the steps from Step 6420, and, conversely, when there is no subsequent virtual volume (Step 6430: NO), ends restore process (Step 6435).

According to the processing described above, a file system that comprises a target file of a user-desired state is restored to the data volume 203. Therefore, the user can read out and use a target file of a required state.

Next, a storage system related to a variation of the present invention will be explained. In the above-described embodiment, a file of the same filename as the target file is presented to the user, but in the storage system related to this variation, information such as the fact that the filename has been changed, or that file migration has been carried out is also provided as target file information.

The storage system related to this variation is configured nearly the same as the storage system related to the embodiment described hereinabove, except that the process related to the creation of a list to be presented to the user by the processor 12 of the NAS apparatus 10 differs. Furthermore, in this variation, the file system will be explained by giving an example of a file system that uses inodes.

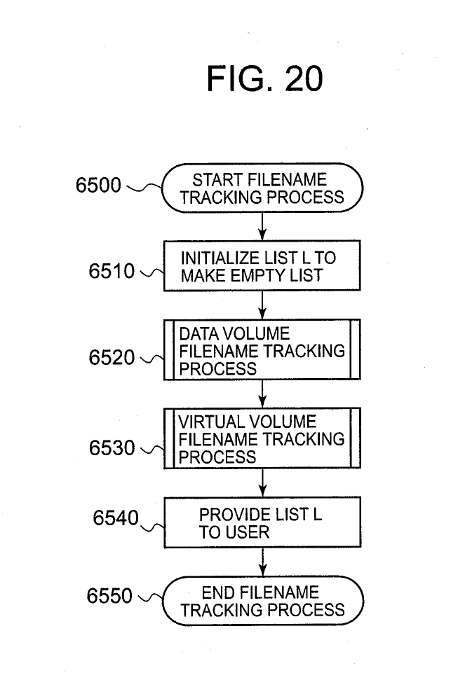

The NAS apparatus 10 of the storage system related to this variation executes a filename tracking process (FIGS. 20 through 22) instead of the processing from Step 6300 through Step 6340.

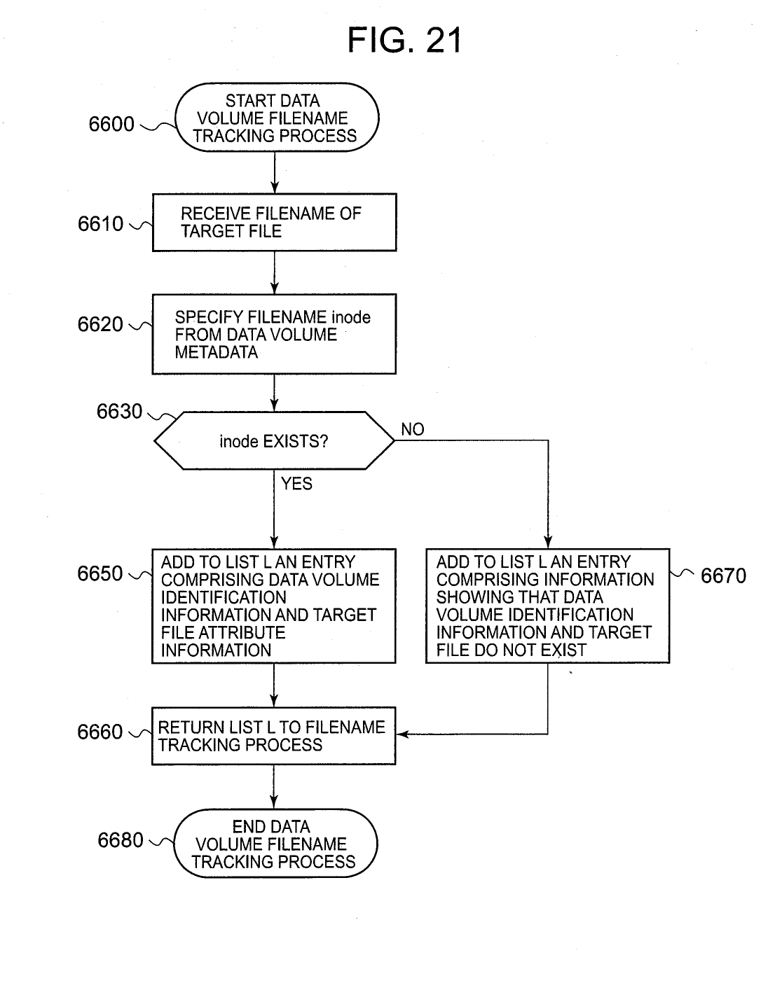

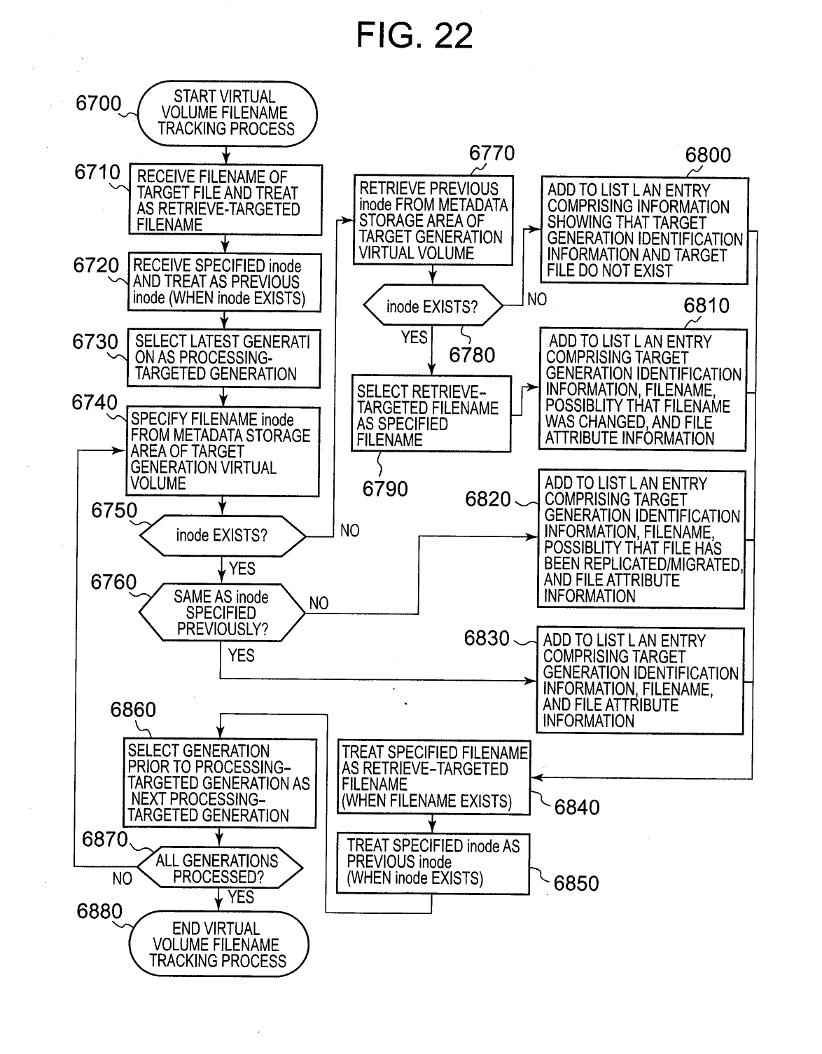

FIG. 20 is a flowchart of a filename tracking process related to the variation of the present invention, FIG. 21 is a flowchart of the filename tracking process in a data volume related to the variation of the present invention, and FIG. 22 is a flowchart of the filename tracking process of a virtual volume related to the variation of the present invention.

When the filename tracking process starts (Step 6500), the processor 12 of the NAS apparatus 10 initializes a list L for a user display as an empty list (Step 6510), and executes filename tracking process for the data volume 203 shown in FIG. 21 (Step 6520).

In the data volume filename tracking process, when processing commences (Step 6600), the processor 12, which executes the restore processing program 18p, receives from the user via a not-shown input device identification data (for example, a filename) of a file (target file) targeted to undergo restore (Step 6610). Next, the processor 12 specifies the inode of the filename from the metadata of the data volume 203 that stores the file system (Step 6620), and determines whether or not the inode exists (Step 6630).

If the result is that the inode exists, the processor 12 adds to the list L an entry comprising the volume ID of the data volume 203, and the metadata (update time, and so forth) of the target file (Step 6650), and, conversely, if the inode does not exist, adds to the list L an entry that comprises information showing that a volume ID (identification information) of the data volume 203 and a target file do not exist (Step 6670). After adding an entry to the list L in either Step 6650 or Step 6670, the processor 12 returns the list L to filename tracking processing (Step 6660), and ends filename tracking processing for the data volume (Step 6680).

When filename tracking processing has ended for the data volume 203, the processor 12 implements the filename tracking processing for the virtual volume 205 shown in FIG. 22 (Step 6530).

When virtual volume filename tracking processing commences (Step 6700), the processor 12 receives the filename of a-target file, and treats this filename as a retrieve-targeted filename (Step 6710). Next, if the inode specified in the filename tracking process for the data volume 203 exists, the processor 12 recognizes this inode as the previous inode (Step 6720), and selects the latest generation as the processing-targeted generation (Step 6730).

The processor 12 specifies the inode, which had been made correspondent to the retrieve-targeted filename, from the metadata storage area in the virtual volume 205 of the generation targeted for processing (Step 6740), and determines whether or not a correspondent inode exists (Step 6750).

When the result is that the inode does not exist (Step 6750: NO), this signifies that a file of the same filename does not exist in (the base point-in-time of) this generation, and as such, the processor 12 searches for the previous inode in the metadata storage area of the virtual volume 205 of the processing targeted generation (Step 6770), and determines whether or not the inode exists (Step 6780).

When the result is that the inode that is the same as the previous inode does not exist, it is conceivable that the target file does not exist in the file system, and as such, the processor 12 adds to the list L an entry comprising information showing that target generation identification information (for example, a generation ID) and a target file do not exist, and proceeds to Step 6840. Conversely, when the inode that is the same as the previous inode does exist in Step 6780, since there is a possibility that the filename of the target file has been changed, the processor 12 selects the retrieve-targeted filename as the specified filename (Step 6790), and adds to the list L an entry comprising identification information of the processing targeted generation, the filename of the specified file (in this case, the retrieve-targeted filename), information showing the possibility that the filename has been changed, and the attribute information of the specified file (for example, the update date/time) (Step 6810), and proceeds to Step 6840.

Conversely, when the determination in Step 6750 is that the inode exists (Step 6750: YES), the processor 12 determines whether or not the specified inode and the previous inode are the same (Step 6760).

When the result is that the specified inode and the previous inode are not the same, since it is conceivable that the file has been subjected to replication or -migration, the processor 12 adds to the list L an entry comprising identification information for the processing targeted generation, the filename of the specified file, information showing that there is a possibility that the file was subjected to replication or migration, and the attribute information of the specified file (for example, the update date/time) (Step 6820), and proceeds to Step 6840. Conversely, when the specified inode and the previous inode are the same, this signifies that the target file exists, and therefore the processor 12 adds to the list L an entry comprising identification information for the processing targeted generation, a filename, and file attribute information (for example, the update date/time) (Step 6830), and proceeds to Step 6840.

In Step 6840, when the specified file exists (when Steps 6810, 6820, and 6830 have been carried out), the processor 12 treats the filename of the specified file as the new retrieve-targeted filename, and when the specified inode exists (when Steps 6810, 6820 and 6830 have been carried out), treats the specified inode as the previous inode (Step 6850).

Next, the processor 12 selects the generation of prior to the processing targeted generation as the subsequent processing targeted generation (Step 6860), and determines whether or not all the generations have been processed as processing targets (Step 6870). When all the generations have not been processed a processing targets, the processor 12 once again executes the steps from Step 6740 (Step 6870: NO), and when all the generations have been processed as processing targets (Step 6870: YES), ends filename tracking processing for the virtual volume (Step 6880).

Returning to the explanation of FIG. 20, when filename tracking processing for the virtual volume (Step 6530) ends, the processor 12 presents the list L to the user (Step 6540). For example, the processor 12 displays the entry information added to the list L on a display device connected to the NAS apparatus 10. Using this display, the user can properly discern the update time of the target file, and can grasp the fact that the target file does not exist in a certain generation, the possibility that the filename has been changed, and the possibility that the file has been replicated or migrated. Thus, even if the file has been migrated, or the filename has been changed, the user can figure out the file comprising the required data. Furthermore, when the user selects the generation comprising the required file from this list L, a restore that restores the data volume of the selected generation is executed using the same processing as that of the embodiment described hereinabove.

The present invention has been explained hereinabove based on the embodiment, but the present invention is not limited to the above-explained embodiment, and is applicable to a variety of other modes.

For example, in the above-described embodiment, when there is a write request for a certain block of the data volume 203, and the difference data of the data of the corresponding block (that is, the data of the base point-in-time of this generation) has already been stored in the difference data storage volume 204 in the same generation, the difference data of the data of the block corresponding to the point in time at which the write request occurred is not stored in the difference data storage volume 204, and the amount of data required for the difference data storage volume 204 is held in check, but regardless of this, the present invention can be configured such that the difference data of the corresponding block data is always stored in the difference data storage volume 204 when there is a write request for the block.

Further, in the above-described embodiment, the configuration is such that all of the metadata in a certain metadata area at the head of the virtual volume of each generation is read out, and the metadata of the targeted file is retrieved. However, the present invention is not limited to this, and, for example, if the file system uses inodes, an address stored in the inode can be determined from the inode number of the retrieve-targeted file, and a read can be carried out relative to the pertinent address, thereby making it possible to rapidly carry out the search process.

Further, in the above-described embodiment, a generation to be restored is selected, and the data volume 203 is restored to the state of the generation base point-in-time, but the present invention is not limited to this, and can be configured such that only the file (only a block that exists in the file) that is being targeted is restored to the state of the generation base point-in-time.

Further, in the above-described embodiment, an example was given in which one difference volume group stores the difference data of one data volume 203, but the present invention is not limited to this, and can be configured such that the difference data of a plurality of data volumes 203 is stored in the same difference volume group. In this case, when a metadata group of a certain base point-in-time of a certain data volume 203 is written to the difference volume group, there are instances when a write of the difference data of another data volume 203 occurs, and the metadata group cannot be written to contiguous blocks of the difference volume group, but even in this case, the area in which the metadata group is stored is concentrated in a relatively narrow range, and also, since the metadata group is stored in a storage area of prior to the difference data in the same generation, a read of the metadata of all the files in this generation can be carried out rapidly. Further, in this case, the metadata and difference data of different data volumes 203 are chronologically stored in the difference volume group, but the configuration can be such that metadata group and difference data in the respective data volumes 203 are managed as a virtual volume 205, that is, the metadata and difference data of the respective data volumes 203 are managed so as to be chronologically arranged in the blocks of the virtual volume. So doing makes it possible to easily acquire in chronological order the metadata and difference data in a desired generation by specifying the virtual volume 205 of the generation of a desired data volume 203.

Further, in the above-described embodiment, metadata of a restore targeted file is retrieved from (the difference volume of) the difference data storage volume 204 of the storage apparatus 200, but the present invention is not limited to this, and can be configured such that a difference volume 205 of at least any one generation is stored in the recording medium 32 by the backup apparatus 31, and the NAS apparatus 10 reads out and retrieves metadata from the difference volume on the recording medium 32 of the backup apparatus 31. Further, the configuration can be such that even when the difference volume has been saved to the recording medium 32, the metadata of all the files of the respective generations is maintained in the difference data storage volume 204 of the storage apparatus 200, and the NAS apparatus 10 reads out the metadata maintained in the difference data storage volume of the storage apparatus 200, and retrieves a restore targeted file. Furthermore, when the restore targeted file is restored in this case, the storage apparatus 200 acquires and restores the required difference data from the recording medium 32 of the backup apparatus 31.

Further, the NAS apparatus 10 is configured such that the metadata of all the files of the respective generations is maintained in the semiconductor memories (for example, the shared memory and/or cache memory) of the storage apparatus 200, and the NAS apparatus 10 retrieves the metadata of a restore targeted file by reading out the metadata maintained in the storage apparatus 200.

Further, in the above-described embodiment, the configuration is such that when a certain generation of the data volume 203 is restored, a restore volume that differs from the data volume 203 is used, and the data in the pertinent generation of the data volume 203 is created in this restore volume. As one method of doing this, for example, in Step 6450 of the volume restore processing shown in FIG. 19, the write destination volume of the difference data can be made the restore volume instead of the data volume 203, and the block into which the difference data was written can be recorded. Then, in Step 6430, after restore processing for all the virtual volumes has ended, data can be read out from the data volume 203 and written to the restore volume for the blocks into which the difference data had not been written. Or, as another method, for example, the data of the data volume 203 can be replicated in the restore volume, and the volume restore processing shown in FIG. 19 can be executed by treating the restore volume as the data volume 203. These methods enable the desired generation of the data volume 203 to be created in the restore volume.

What is claimed is:

1. A storage system comprising:
a storage apparatus, which stores a volume that stores, for one or more files, a file system comprising real data and metadata that comprises the update time information of the files, and which receives a block write request that specifies a block of the volume; and
a file server, which receives from a computer a file write request that specifies a file, specifies a block of the volume in which the file specified by the file write request is stored, and sends a block write request that specifies the block of the specified volume to the storage apparatus,
wherein the file server has a write processing unit, which reads from the volume the metadata of all files included in the file system at a plurality of base points-in-time serving as bases for the restoration of the volume, and which sequentially writes all the read-in metadata to a prescribed difference data storage volume of the storage apparatus, and
the storage apparatus has a difference data save processing unit, which, upon receiving the block write request from the latest base point-in-time to the subsequent base point-in-time, chronologically writes the data stored in the block specified by the block write request to a storage area subsequent to the storage area in which the metadata of the difference data storage volume has been written.

2. The storage system according to claim 1, wherein the file server comprises:
an identification data receiving unit that receives identification data of a restore-targeted file;
a retrieval unit that retrieves metadata comprising the identification data by reading the storage area in which the metadata of the difference data storage volume is stored;
an acquisition unit that acquires the update time information of the restore-targeted file from the metadata when metadata comprising the identification data is capable of being retrieved by the retrieval unit; and
a presentation unit that presents a list related to the restore-targeted files comprising the acquired update time information.

3. The storage system according to claim 2, wherein the metadata comprises a plurality of inodes comprising block numbers of the volume in which real data corresponding to the respective files is stored, and the correspondence relationship between the identification data and the inodes, and
the file server further comprises:
a determination unit, which acquires a first inode that corresponds to the identification data of a first base point-in-time, and when the first inode exists without a second inode that corresponds to the identification data of the subsequent base point-in-time, determines that there is a possibility that the identification data of this inode has been changed, and
the presentation unit presents information showing that there is a possibility that the identification data has been changed, and update time information.

4. The storage system according to claim 2, wherein the file server further comprises:
a restore specification processing unit, which receives a specification from the list as to the update time of the restore-targeted file to be restored, and notifies the specification to the storage apparatus, and
the storage apparatus further comprises:
a restore processing unit that reads out data required to restore the restore-targeted file of the update time corresponding to the specification from the difference data storage volume, and restores the restore-targeted file.

5. The storage system according to claim 2, wherein the storage apparatus further comprises:
a semiconductor memory capable of storing data, the file server further comprises:
a cache controller that stores the metadata of all files at a plurality of the base points-in-time stored in the difference data storage volume in the semiconductor memory, and
the retrieval unit retrieves metadata comprising the identification data from the metadata stored in the semiconductor memory.

6. The storage system according to claim 4, further comprising:
an external device capable of storing data,
wherein the storage apparatus further comprises:
a save unit that saves data of the difference data storage volume to the external device, and
the restore processing unit reads out, from the external device, data required to restore the restore-targeted file in a state corresponding to the specification, and restores the restore-targeted file.

7. The storage system according to claim 6, wherein the storage apparatus further comprises:
a metadata maintenance unit that maintains the metadata in the difference data storage volume subsequent to saving the data of the difference data storage volume to the external device, and
the retrieval unit retrieves metadata comprising the identification data from the metadata of the difference data storage volume.

8. The storage system according to claim 1, wherein the difference data save processing unit of the storage apparatus uses the storage area of the difference data storage volume to create a virtual volume such that the metadata of all the files of one base point-in-time is stored in contiguous storage areas, and that data written by the difference data save processing unit is stored in a storage area subsequent to the metadata storage area from the one base point-in-time to the subsequent base point-in-time..

9. A data management method for a storage system that comprises a storage apparatus, which stores a logical volume that stores, for one or more files, a file system comprising real data and metadata that comprises the update time information of the files, and which receives a block write request that specifies a block of the logical volume; and a file server, which receives from a computer a file write request that specifies a file, specifies a block of the logical volume in which the file specified by the file write request is stored, and sends a block write request that specifies the block of the specified logical volume to the storage apparatus, the data management method comprising:
write processing step of reading from the logical volume the metadata of all files included in the file system at a plurality of base points-in-time serving as bases for the restoration of the logical volume, and sequentially writing all the read-in metadata to a prescribed difference data storage volume of the storage apparatus; and
difference data save processing step of chronologically writing data stored in the block specified by the block write request to a storage area subsequent to the storage area to which the metadata of the difference data storage volume has been written when the storage apparatus receives the block write request from each base point-in-time to the subsequent base point-in-time.

10. The data management method according to claim 9, wherein the file server executes:
identification data receiving step of receiving identification data of a restore-targeted file;
retrieving step of retrieving metadata comprising the identification data by reading the storage area in which the metadata of the difference data storage volume is stored;
acquiring step of acquiring the update time information of the restore-targeted file from the metadata when metadata comprising the identification data is capable of being retrieved; and
presenting step of presenting a list related to the restore-targeted files comprising the acquired update time information.

11. The data management method according to claim 10, wherein the metadata comprises a plurality of inodes comprising a block number of the volume in which real data corresponding to respective files is stored, and the correspondence relationship between the identification data and the inodes, the data management method further comprising:
determining step of acquiring a first inode that corresponds to the identification data of a first base point-in-time, and when the first inode exists without a second inode that corresponds to the identification data of the subsequent base point-in-time, determining that there is a possibility that the identification data of this inode has been changed, and
the presenting step presents information showing that there is a possibility that the identification data has been changed, and update time information.

12. The data management method according to claim 10, further comprising:
restore specification processing step of receiving a specification from the list as to the update time of the restore-targeted file to be restored, and notifying the specification to the storage apparatus; and
restore processing step of reading out data required to restore the restore-targeted file of the update time corresponding to the specification from the difference data storage volume, and restoring the restore-targeted file.

13. The data management method according to claim 10, wherein the storage apparatus comprises a semiconductor memory capable of storing data, the data management method further comprising:
cache execution step of storing the metadata of all files at a plurality of the base points-in-time stored in the difference data storage volume in the semiconductor memory, and
the retrieving step retrieves metadata comprising the identification data from the metadata stored in the semiconductor memory.

14. The data management method according to claim 13, wherein the storage system further comprises an external device capable of storing data, the data management method further comprising:
saving step of saving data of the difference data storage volume to the external device, and
the restore processing step reads out, from the external device, data required to restore the restore-targeted file in a state corresponding to the specification, and restores the restore-targeted file.

15. The data management method according to claim 9, wherein the difference data save processing step uses a storage area of the difference data storage volume to create a virtual volume such that metadata of all files of one base point-in-time is stored in contiguous storage areas, and that the data of a block specified by the block write request is stored in a storage area subsequent to the metadata storage area from the one base point-in-time to the subsequent base point-in-time.
